(19) United States
(12) Patent Application Publication
(10) Pub. No.: US 2026/0332473 A1
(43) Pub. Date: Oct. 22, 2026

(54) NETWORK PERFORMANCE ANALYZER

(71) Applicant: T-Mobile USA, Inc., Bellevue, WA (US)

(72) Inventors: Chetana V. Murudkar, Tampa, FL (US); Julio Costa, Tampa, FL (US)

(21) Appl. No.: 19/183,472

(22) Filed: Apr. 18, 2025

(51) Int. Cl. H04L 41/0806; H04L 41/16; H04L 41/5009; H04W 16/18

(52) U.S. Cl. CPC H04L 41/0806; H04L 41/16; H04L 41/5009; H04W 16/18

(57) ABSTRACT

Network features, parameters, counters, and key performance indicators (KPIs) are extracted from a software release package document using a natural language processing model. The network features are mapped to the parameters, counters, and KPIs. A deployment date of a network feature is extracted from a deployment schedule. Pre-and post-statistical trends of a KPI before and after the deployment date respectively are determined and a pre-post analysis is conducted. The KPI is classified as improved, degraded, or stable based on the pre-post analysis. The KPI is classified as improved if a difference between the post and the pre statistical trends indicates an improvement in network performance. The KPI is classified as degraded if the difference between the post and the pre statistical trends indicates a degradation in network performance. The KPI is classified as stable if the difference between the post and the pre statistical trends indicates no change in network performance.

### BACKGROUND

Network performance analysis is an activity that entails the data collection and review of key metrics of a telecommunications infrastructure to identify underperforming areas. The network performance data collected is generally obtained from network performance testing tools. The benefits of this activity include cost reduction and improved end-user experience and customer satisfaction. Network performance analysis helps organizations optimize network resources, ensuring efficient bandwidth allocation, including the application of quality of service (QoS) policies. Network performance analysis provides insights into current network usage patterns, helping organizations plan for future capacity needs and expansions effectively.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram of a process for mapping network features, network configuration parameters, network performance counters, and network key performance indicators (KPI) that includes aspects of the disclosed technology.

FIG. 4 is a block diagram of a process for performing pre-post analysis that includes aspects of the disclosed technology.

FIG. 5 is a block diagram of a process for performing correlation analysis that includes aspects of the disclosed technology.

FIG. 6 is a block diagram of a process for performing root cause analysis that includes aspects of the disclosed technology.

FIG. 7 is a flowchart of a method in which aspects of the disclosed technology are implemented.

FIG. 8 is a block diagram that illustrates an example AI system that can implement aspects of the present technology.

FIG. 9 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to methods and devices for automated network performance analysis and network performance impact causation determination for network upgrades and/or network feature deployments in a wireless telecommunications network. The disclosed technology includes use of machine learning (ML) algorithms, statistical algorithms, natural language processing, and large language models (LLMs) to identify correlations between deployment schedules, key performance indicators (KPIs), and network configuration parameters to determine whether a network performance-impacting event such as a software upgrade, a hardware upgrade, a network feature deployment, or a network optimization activity resulted in an improvement, a degradation, or no change in a network performance metric. In some embodiments, the disclosed technology can include multi-model reasoning and text-to-SQL querying capabilities for actionable insights and enhanced automation. In some embodiments, the disclosed technology can automatically generate, using an LLM, textual instructions to improve a KPI. In some embodiments, the disclosed technology can automatically generate textual instructions to modify a network configuration parameter.

In some embodiments, a device implementing the disclosed technology can receive input data in the form of at least one of software release package documentation, a network feature deployment schedule, software release details, KPIs, network configuration parameter definitions, or network feature documentation. In some embodiments, the device can automatically perform a pre-post deployment KPI analysis using ML anomaly detection techniques and LLM-based insights to identify deviations in a first KPI. In some embodiments, the device can perform network feature and network performance parameter mapping to map affected KPIs to corresponding network features and parameters for deeper analysis using hybrid models. In some embodiments, the device can perform a correlation analysis between a network configuration feature and a KPI to determine a direction and a strength of a correlation between the two. In some embodiments, the device can segment KPI trends geographically to determine market-specific network performance trends. In some embodiments, the device can automatically perform a root cause analysis (RCA) to identify a cause of improvement or degradation in the first KPI using a cross-layer RCA technique and LLM reasoning. In some embodiments, the device can automatically generate at least one textual instruction using an LLM to improve a KPI trend or at least one textual instruction to change a network configuration parameter. In some implementations, the device can automatically generate textual summarized findings to guide future software upgrades using LLM-generated narratives.

In some embodiments, a method implementing the disclosed technology can validate whether an outcome of a network upgrade or a network feature deployment trial is as expected. In some implementations, the method can include a baseline analysis to determine a network KPI benchmark value before the network upgrade or network feature deployment. In some implementations, the method can include performing an RCA to identify a cause of an unexpected degradation in the network KPI in the post deployment statistical trend. In some implementations, the method can perform a geographical analysis of network performance to determine a success status of the network upgrade or the feature deployment in various geographical regions covered by the wireless telecommunications network. In some implementations, the method can group network KPIs and network performance counters by geographical region or market. In some implementations, the method can determine a statistical pattern in regional or market trends. In some implementations, the method can generate at least one actionable network configuration parameter change based on historical network KPI data and relational analysis between the network KPI and various network configuration parameters. In some implementations, the method can analyze historical data to determine a trend by associating a past network configuration parameter change with an improvement in a network KPI. In some implementations, the method can perform a relational analysis using correlation, SHAP, or ML models to determine the impact of a network configuration parameter on network KPIs. In some implementations, the method can compare network, geographical, or environmental conditions that are known to the operator of the wireless telecommunications network to be similar in a plurality of markets, geographical regions, or time periods when their respective network KPIs showed similar statistical trends and generate at least one textual instruction to adjust a network configuration parameter value. In some implementations, the method can use an LLM to generate a textual statement of key statistical relationships between at least two of a network upgrade, a network feature, a network configuration parameter, a network KPI, and a network performance counter. In some implementations, the method can generate, using an LLM, a natural language report that includes textual explanations for network KPI changes, statistical discrepancies, and network optimization recommendations. In some implementations, the method can generate a textual roadmap. The roadmap can comprise a list of network features that resulted in a network performance improvement and a list of network features that can be implemented in the wireless telecommunications network. In some implementations, the textual roadmap can comprise a list of network features that can be adjusted before a subsequent network upgrade or network feature deployment, next rollout to align with a known business priority, or a known network expansion goal provided to the method by the operator of the wireless telecommunications network.

The inventors have recognized a need for an automated, self-contained, end-to-end solution for performing network performance analysis, anomaly detection, and network configuration parameter modification. Existing methods for the above are either slow, laborious, or simplistic when done by humans. For example, humans are incapable of performing advanced iterative statistical calculations, higher order trend analysis, or implementing ML techniques in a cost-and time-efficient manner. Recognizing this need, the inventors have proposed the methods and devices disclosed herein. When implemented, the technology disclosed herein can automate network performance analysis using advanced LLM functionalities, thereby reducing manual effort and errors. The disclosed technology also enables natural language interactions for database queries and RCA and enhances anomaly detection and optimization through hybrid reasoning models. In some embodiments, the disclosed technology can perform network performance analysis that is scalable for network cell-level to national-level deployments. In some embodiments, the disclosed technology can create a roadmap for optimizing future software upgrades and network performance. The technology disclosed herein can be implemented by an operator of a wireless telecommunications network for a variety of purposes, including software rollout management, network performance monitoring, network performance impact RCA, technology strategy planning for network feature releases, network performance optimization, geography-or market-specific network performance assessments and improvements, and proactive network configuration parameter optimization to improve network performance.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

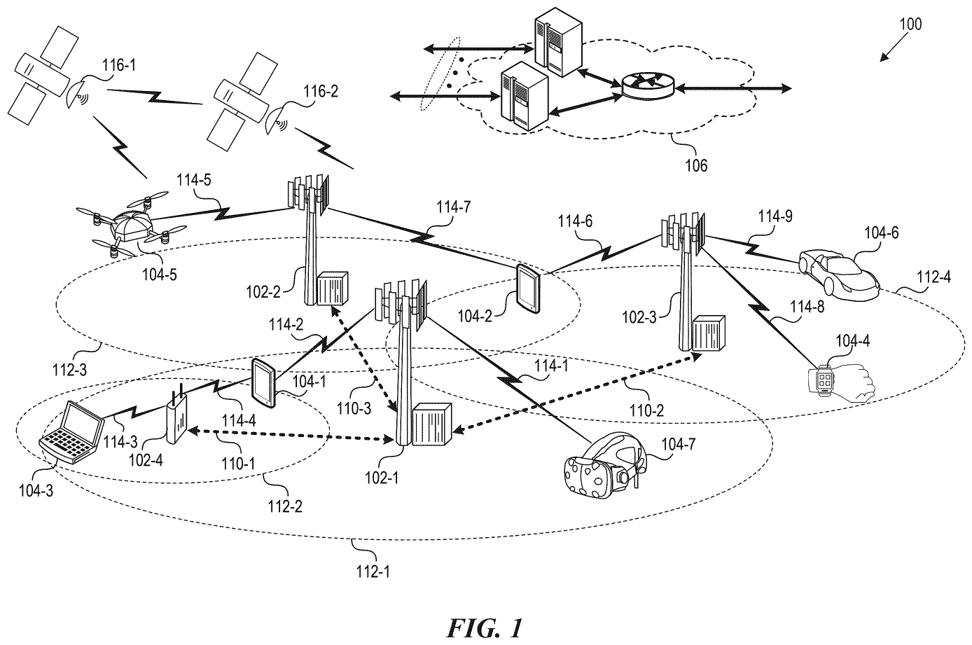

FIG. 1 is a block diagram that illustrates a wireless telecommunication network 100 (“network 100”) in which aspects of the disclosed technology are incorporated.
The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 or N2 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1, X2, or Xn interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally, or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

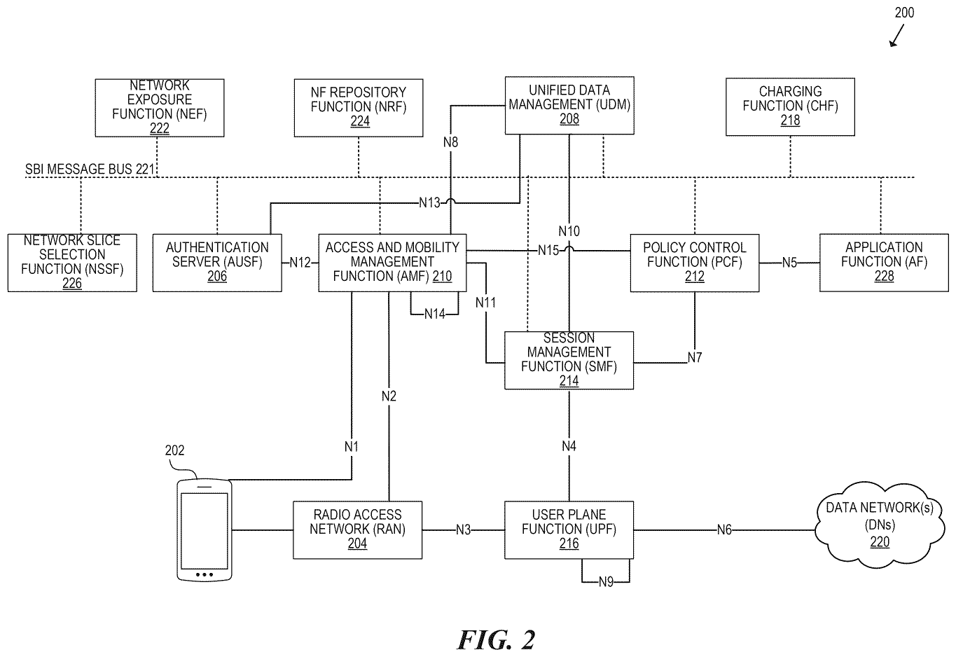

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information ausfexternally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Automated Performance Analysis and Causation Determination Using Natural Language Processing and Large Language Models

In embodiments when the disclosed methods are implemented, network features, parameters, counters, and key performance indicators (KPIs) are extracted from a software release document using a natural language processing model. The network features are mapped to the parameters, counters, and KPIs. A deployment date of a network feature is extracted from a deployment schedule. Pre-and post-statistical trends of a KPI before and after the deployment date respectively are determined and a pre-post analysis is conducted. A KPI is classified as improved if the post-deployment trend reflects performance gains relative to the pre-deployment trend, degraded if performance declines, and stable if no significant change is observed. Based on these classifications and their correlation to specific features and parameters, the method can include generation of a roadmap of recommended actions providing actionable insights for root cause analysis and network optimization. This enables automated performance tracking, impact assessment, and strategic planning for network feature deployment and evolution.

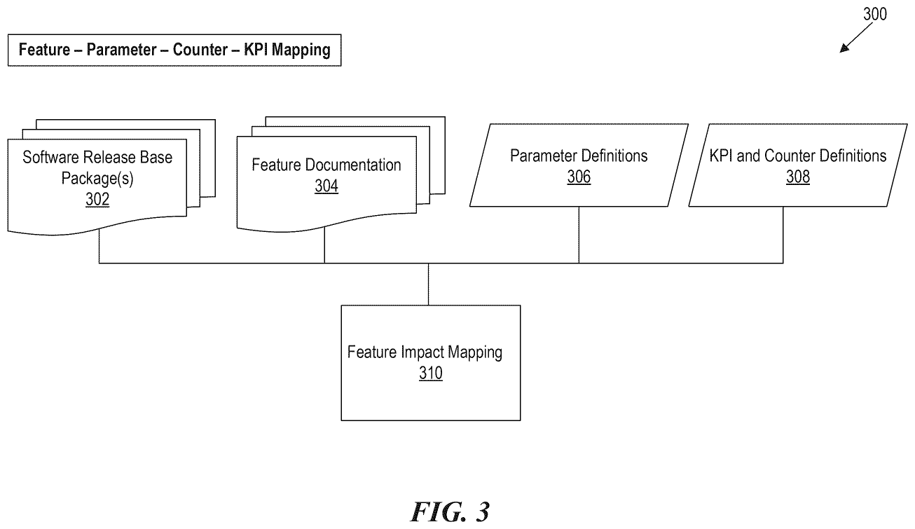

FIG. 3 is a block diagram of a process 300 for mapping network features, network configuration parameters, network performance counters, and network key performance indicators (KPI) that includes aspects of the disclosed technology. In some embodiments, at 302, a software release base package of a network software is provided. The software release base package can include at least one network feature that can impact a performance metric of the wireless telecommunications network. The at least one network feature can be controlled by at least one network configuration parameter associated with the network feature. An impact of deploying the network feature, whether positive or negative, can be observed in at least one network performance counter or at least one network KPI. At 304, documentation associated with the network feature is provided. The feature documentation can contain, for example, technical details of how the feature works, network configuration parameters, network performance counters, and network KPIs associated with or impacted by the feature. At 306, network configuration parameter definitions are provided, including, for example, technical, implementation, or operational details associated with the network configuration parameter. At 308, network KPI and network performance counter definitions are provided. Each network performance counter can by itself be considered indicative of the impact to the network or can be combined with other network performance counters to form a network KPI. Examples of network performance counters include, for example, a count of subscribers connected to a node of the wireless telecommunications network in a given period, a number of connection requests received at the node within a given period, the number of connection requests allowed, a number of active connections dropped by the network, etc. Examples of network KPIs include a connection failure rate, which is determined, for example, by dividing a number of failed connection requests by a total number of connection requests received within a given period, etc. A person having ordinary skill in the art will recognize that hundreds of counters and KPIs can be associated with the operation of a wireless telecommunications network.

At 310, the process 300 includes automatic network feature impact mapping. In some embodiments, the network feature impact mapping can include automatically extracting network features, network configuration parameters, network performance counters, and network KPIs from the feature documentation and creating functional or operational associations between them. In some implementations, the operation can include the use of an NLP algorithm to extract the network features, network configuration parameters, network performance counters, and KPIs from the feature documentation. In some implementations, the feature impact mapping operation 310 can include graphically representing the associations between the network features, network configuration parameters, network performance counters, and network KPIs. In some implementations, the use of the NLP algorithm operation 310 can further include text processing, keyword matching, or contextual analysis for feature impact mapping.

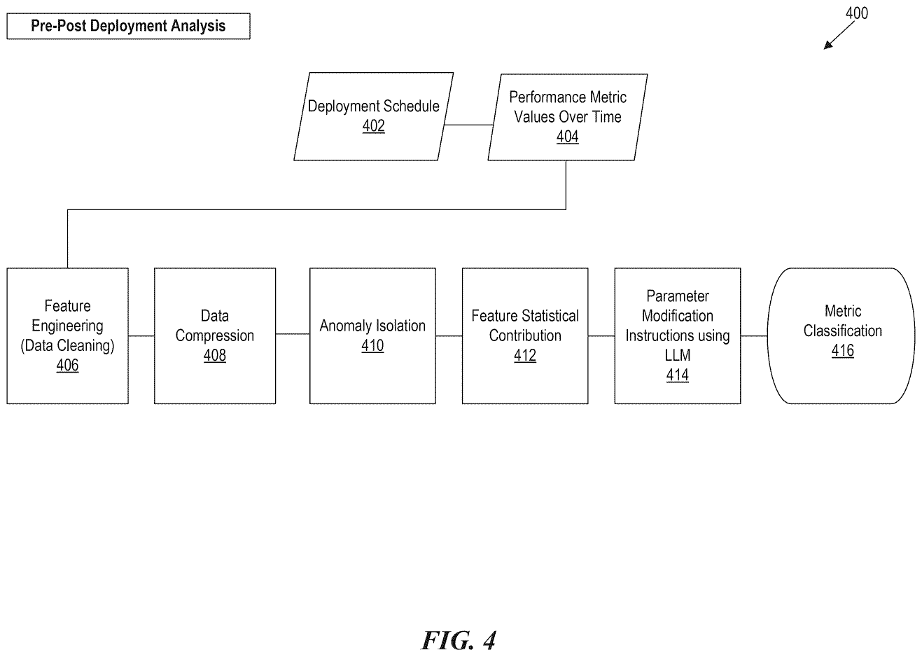

FIG. 4 is a block diagram of a process 400 for performing pre-post analysis that includes aspects of the disclosed technology. At 402, a deployment schedule including a date and/or time of a feature deployment or network upgrade can be provided. At 404, the process 400 can include an operation to determine statistical trend of a network KPI over a threshold duration before a deployment date and/or time of the network feature or network upgrade, which can be referred to herein as the pre statistical trend of the network KPI. At 404, the process can further include an automated operation to determine statistical trend of a network KPI over a threshold duration after a deployment date and/or time of the network feature or network upgrade, which can be referred to herein as the post statistical trend of the network KPI.

At 406, the process 400 can include an operation to clean statistical data associated with the network KPI or the network performance counter. In some implementations, the operation 406 can include using a seasonal and trend decomposition using locally estimated scatterplot smoothing (LOESS)(STL) statistical algorithm to automatically remove statistical noise from the network KPI's pre or post statistical trend caused by seasonal variations in the network KPI's statistical trend. Seasonal decomposition is a statistical technique for breaking down a data time series into its essential components, which can include the trend, seasonal patterns, and residual (or error) components to separate the different sources of variation within the data for analyzing each component independently. A trend component is an underlying long-term progression or direction in the network KPI or network performance counter data. A seasonal component is a repeating pattern or cycle that can occur at fixed intervals like daily, monthly, or yearly within the network KPI or network performance counter data. A residual component is a random fluctuation or statistical noise in the data that cannot be attributed to the trend or seasonal patterns. Locally weighted scatterplot smoothing (also referred to herein as LOESS) is a non-parametric regression method used for smoothing data. In the context of the time series analysis disclosed here, Seasonal trend decomposition using LOESS (STL) is a specific decomposition method that employs the LOESS technique to separate a time series into its trend, seasonal, and residual components. Thus, operation 406 can result in preventing predictable fluctuations from being misclassified as statistical anomalies.

At 408, the process 400 can include an operation for data compression that can preprocess and simplify high-dimensional network KPI or network performance counter data to make it easier to detect anomalies. In some implementations, the operation 408 can include an autoencoding function comprising an encoder for compressing the input data into a lower-dimensional latent space and a decoder for reconstructing the original data from the compressed representation while ensuring minimal information loss. In some implementations, the operation 408 can compress data into a smaller representation for further processing. At 410, the process 400 can include an operation for statistical anomaly isolation. In some implementations, the operation 410 can include an isolation forest algorithm to identify anomalous data points with high anomaly scores. In some implementations, the operation 410 can isolate anomalies in the cleaned, compressed data produced by STL and the autoencoder of operation 408.

At 412, the process 400 can include an operation to automatically determine importance of the network or statistical feature to the data trend. In some implementations, the operation 412 can include a Shapley additive explanations (SHAP) algorithm to compute a statistical contribution of a network KPI or network performance counter to the anomaly score. At 414, the process 400 can include an automated operation to generate a textual explanation and/or an actionable instruction to improve the statistical trend of the network KPI or the network performance counter. In some implementations, the operation 414 can include use of an LLM to convert a raw anomaly score into an actionable textual instruction to improve the statistical trend of the network KPI or the network performance counter or to modify a value of the network configuration parameter to a new value. At 416, the process 400 can include an operation to automatically classify the network performance KPI as an improved metric, a degraded metric, or a stable metric. The network KPI can be classified as an improved metric when the network KPI shows an expected improvement. The network KPI can be classified as a degraded metric when the post deployment statistical trend of the network KPI shows a worsened change compared to the pre deployment statistical trend. The network KPI can be classified as a stable metric when no significant change is observed in the statistical trend of the network KPI before and after the deployment.

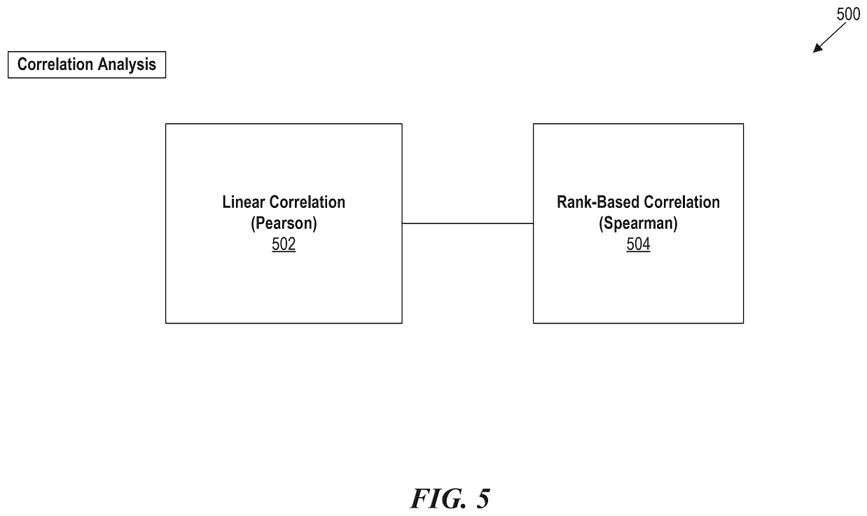

FIG. 5 is a block diagram of a process 500 for performing correlation analysis that includes aspects of the disclosed technology. In some implementations, at 502, the process 500 can include an operation to determine a Pearson correlation coefficient to determine whether a linear correlation exists between a network configuration parameter and a network KPI. For example, when a linear correlation exists between a network configuration parameter and a network KPI such that a change in the network KPI is directly proportional to a change in the network configuration parameter value, the Pearson correlation coefficient can have a positive value between 0 and 1. When a linear correlation exists between the network configuration parameter and the network KPI such that a change in the network KPI is inversely proportional to a change in the network configuration parameter value, the Pearson correlation coefficient can have a negative value between-1 and 0. When no correlation exists between the network configuration parameter and the network KPI, the Pearson correlation coefficient can be 0.

In some implementations, at 504, the process 500 can include an operation to determine a Spearman correlation coefficient to determine whether a rank-based correlation exists between a network configuration parameter and a network KPI. In some implementations, the operation 504 can determine whether a ranking of values in one variable, such as the network configuration parameter, aligns with a ranking in another variable, such as the network KPI. In some implementations, the operation 504 can include automatic generation of a matrix having multiple network configuration parameters along one dimension of the matrix, multiple network KPIs along another dimension of the matrix, and a Spearman correlation coefficient indicating a rank-based correlation between each corresponding combination of network configuration parameter and network KPI.

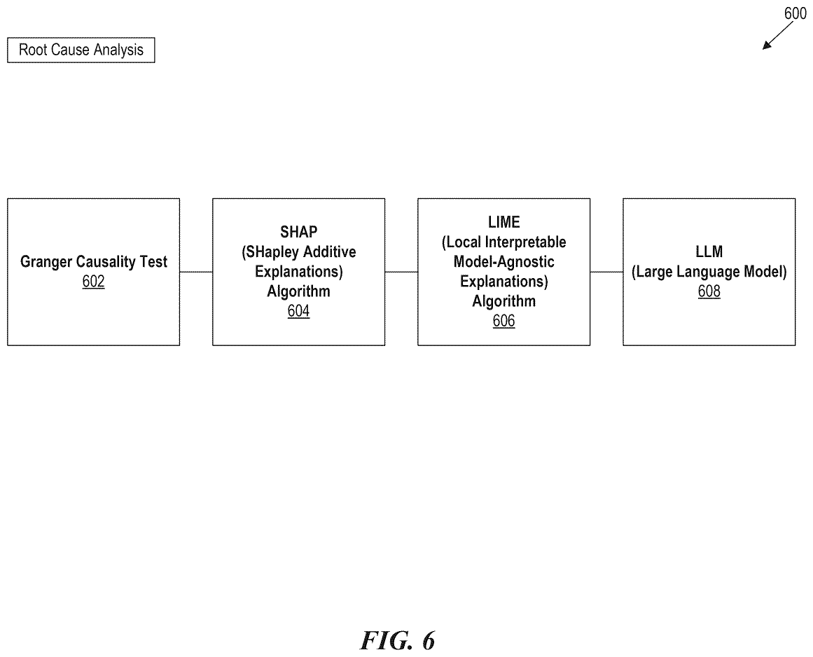

FIG. 6 is a block diagram of a process 600 for performing RCA that includes aspects of the disclosed technology. In some implementations, the process 600 can determine a contribution of a network configuration parameter to a change in network KPI. In some implementations, the process 600 can determine a Shapley value that represents an average marginal contribution of a network configuration parameter change to a network KPI change. In some implementations, the process 600 can use a local interpretable model-agnostic explanation (LIME) model to automatically determine a contribution of a network configuration parameter change to a network KPI change. In some implementations, the process 600 can use an LLM to determine a contribution of a network configuration parameter change to a network KPI change.

In some implementations, the process 600 can include an operation 602 in which a Granger causality test is used to determine whether changes in a network configuration parameter cause changes in a network KPI over a given time period. The Granger causality test can use time series data to determine whether a temporal relationship exists between a network configuration parameter and a network KPI. In some implementations, the process 600 can include an operation 604 in which a SHAP (SHapley Additive Explanations) algorithm is used to determine a contribution of a particular network configuration parameter change to network KPIs of the wireless telecommunications network at a global scale or to network KPIs of a node or a group of nodes of the wireless telecommunications network at a local level. In some implementations, the process 600 can include an operation 606 in which a LIME algorithm is used to determine a specific impact of a network configuration parameter to an individual network node, a specific region, or a specific time period. In some implementations, the process 600 can include an operation 608 in which an LLM is used to represent a technical or statistical relationship between any two or more of a network feature, a network configuration parameter, a network KPI, or a network performance counter into a textual or human-readable statement or instruction. In an example implementation of process 600 of the disclosed technology, a deployment of a first network feature in multiple geographical regions of the wireless telecommunications network resulting in multiple local trends of a first network KPI can be analyzed. The operation 602 can determine using the Granger causality algorithm that the first network feature deployment correlates to changes in the first network KPI. Further, the SHAP algorithm of operation 604 can determine that a first network configuration parameter and a second network configuration parameter are top contributors to changes in the first network KPI. The LIME algorithm of operation 606 can automatically determine that the first network KPI of a first network node was primarily affected by a change in the first network configuration parameter, whereas the first network KPI of a second network node was primarily affected by a change in the second network configuration parameter.

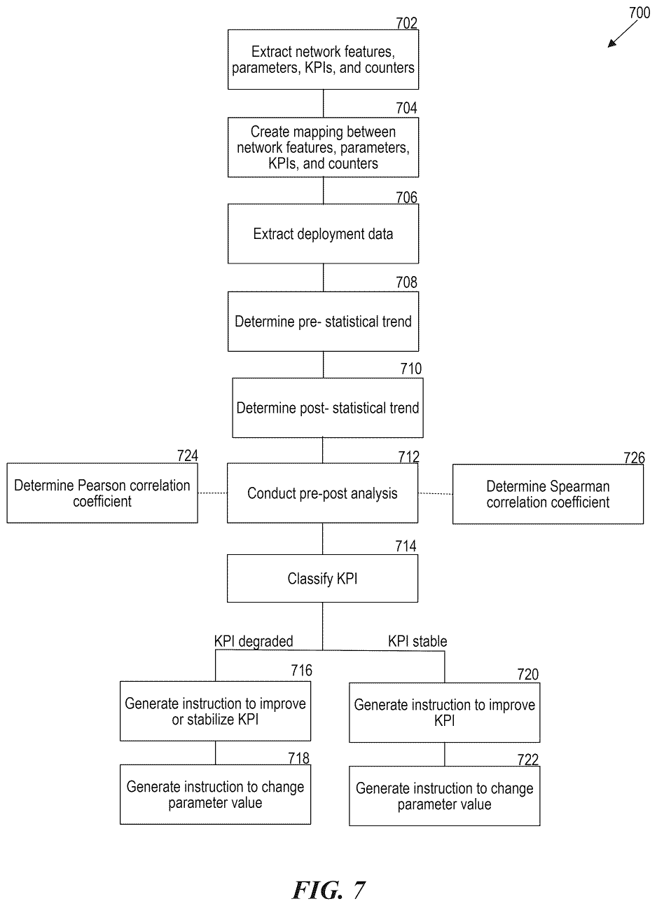

FIG. 7 is a flowchart of a method 700 in which aspects of the disclosed technology are implemented. At 702, a list of network features, a list of network configuration parameters associated with each network feature, a list of counters associated with each network feature, and a list of KPIs associated with each network feature can be extracted from a software release package document, using a natural language processing model. At 704, each of the extracted network features can be automatically mapped to at least one extracted network configuration parameter, at least one extracted network performance counter, and at least one extracted KPI. At 706, a deployment date of a first network feature can be extracted from the extracted list of network features. At 708, a pre statistical trend of a first KPI associated with the first network feature before the deployment date can be determined. At 710, a post statistical trend of the first KPI associated with the first network feature after the deployment date can be determined. At 712, an automated pre-post analysis of a deployment of the first network feature by comparing the pre and the post statistical trends can be performed. In some implementations, performing the pre-post analysis can further include automatically removing at least one anomalous data point from the pre or post statistical trend using a seasonal trend decomposition using a LOESS algorithm. In some implementations, performing the pre-post analysis can further include automatically removing at least one anomalous data point from the pre or post statistical trend using an isolation forest algorithm.

At 714, the first KPI can be automatically classified as improved, degraded, or stable based on the pre-post analysis. The first KPI can be classified as improved if a difference between the post and the pre statistical trends indicates an improvement in network performance. The first KPI can be classified as degraded if the difference between the post and the pre statistical trends indicates a degradation in network performance. The first KPI can be classified as stable if the difference between the post and the pre statistical trends indicates no change in network performance. Based on these classifications and their correlation to specific features and parameters, the method can include generation of a roadmap of recommended actions, including parameter tuning, feature reconfigurations, and prioritization for future rollouts providing actionable insights for root cause analysis and network optimization. The method can enable automated performance tracking, impact assessment, and strategic planning for network feature deployment and evolution.

At 716, when the first KPI is classified as degraded, at least one textual instruction for changing the classification of the first KPI to stable or improved can be automatically generated using a large language model. At 718, when the first KPI is classified as degraded, at least one textual instruction to change the first network configuration parameter from a first value to a second value can be automatically generated using a large language model. When the first network configuration parameter is changed to the second value, the classification of the first KPI can be changed to stable or improved. At 720, when the first KPI is classified as stable, at least one textual instruction for changing the classification of the first KPI to improved can be automatically generated using a large language model. At 722, when the first KPI is classified as stable, at least one textual instruction to change the first network configuration parameter from a first value to a second value can be automatically generated using a large language model. When the first network configuration parameter is changed to the second value, the classification of the first KPI can be changed to improved. At 724, a Pearson correlation coefficient based on a linear correlation analysis of the first network configuration parameter and the first KPI can be determined. At 726, a Spearman's rank correlation coefficient based on a rank-based correlation analysis of the first network configuration parameter and the first KPI can be determined.

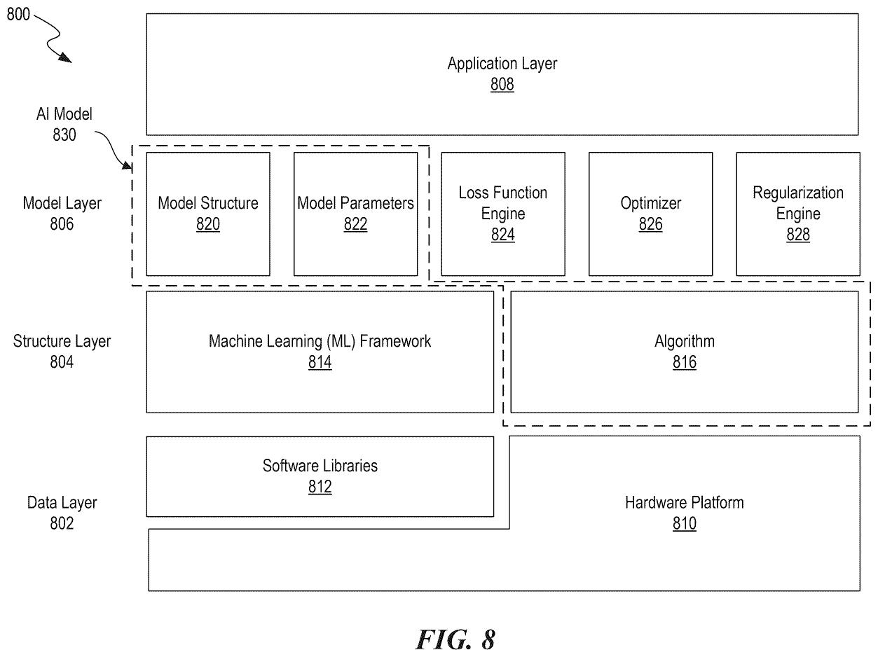

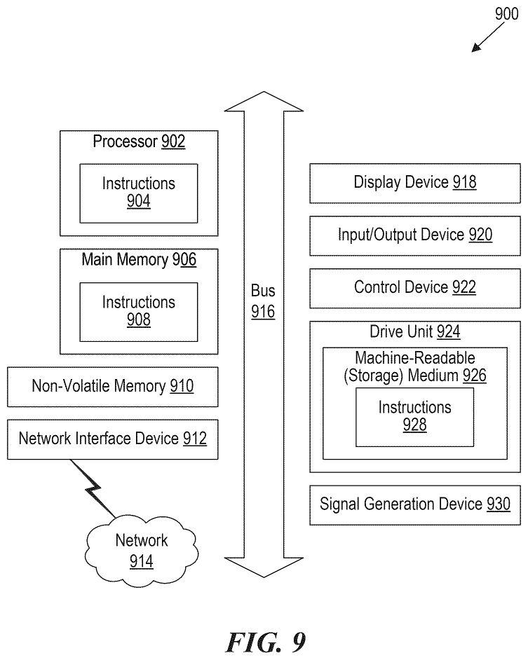

FIG. 8 is a block diagram that illustrates an example AI system 800 that can implement aspects of the present technology. The AI system 800 is implemented using components of the example computer system 900 illustrated and described in more detail with reference to FIG. 9. For example, the AI system 800 can be implemented on the processor 902 using instructions 908 programmed in the memory 906 illustrated and described in more detail with reference to FIG. 9. Likewise, implementations of the AI system 800 can include different and/or additional components or be connected in different ways. FIG. 8 illustrates a layered architecture of AI system 800 that can implement the NLP model of 310, or the LLMs of 414 or 608. Accordingly, the NLP model of 310 or the LLMs of 414 or 608 can include one or more components of the AI system 800.

As shown, the AI system 800 can include a set of layers, which conceptually organize elements within an example network topology for the AI system's architecture to implement a particular AI model 830. Generally, an AI model 830 is a computer-executable program implemented by the AI system 800 that analyzes data to make predictions. Information can pass through each layer of the AI system 800 to generate outputs for the AI model 830. The layers can include a data layer 802, a structure layer 804, a model layer 806, and an application layer 808. The algorithm 816 of the structure layer 804 and the model structure 820 and model parameters 822 of the model layer 806 together form an example AI model 830. The optimizer 826, loss function engine 824, and regularization engine 828 work to refine and optimize the AI model 830, and the data layer 802 provides resources and support for application of the AI model 830 by the application layer 808.

The data layer 802 acts as the foundation of the AI system 800 by preparing data for the AI model 830. As shown, the data layer 802 can include two sub-layers: a hardware platform 810 (e.g., the computer system 900 described in more detail with reference to FIG. 9) and one or more software libraries 812. The hardware platform 810 can be designed to perform operations for the AI model 830 and include computing resources for storage, memory, logic and networking, such as the resources described in relation to FIG. 9. The hardware platform 810 can process amounts of data using one or more servers. The servers can perform backend operations such as matrix calculations, parallel calculations, machine learning (ML) training, and the like. Examples of servers used by the hardware platform 810 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 810 can include computing resources, (e.g., servers, memory, etc.) offered by a cloud services provider. The hardware platform 810 can also include computer memory for storing data about the AI model 830, application of the AI model 830, and training data for the AI model 830. The computer memory can be a form of random-access memory (RAM), such as dynamic RAM, static RAM, and non-volatile RAM.

The software libraries 812 can be thought of as suites of data and programming code, including executables, used to control the computing resources of the hardware platform 810. The programming code can include low-level primitives (e.g., fundamental language elements) that form the foundation of one or more low-level programming languages, such that servers of the hardware platform 810 can use the low-level primitives to carry out specific operations. The low-level programming languages do not require much, if any, abstraction from a computing resource's instruction set architecture, allowing them to run quickly with a small memory footprint. Examples of software libraries 812 that can be included in the AI system 800 include INTEL Math Kernel Library, NVIDIA cuDNN, EIGEN, and OpenBLAS.

The structure layer 804 can include an ML framework 814 and an algorithm 816. The ML framework 814 can be thought of as an interface, library, or tool that allows users to build and deploy the AI model 830. The ML framework 814 can include an open-source library, an application programming interface (API), a gradient-boosting library, an ensemble method, and/or a deep learning toolkit that work with the layers of the AI system to facilitate development of the AI model 830. For example, the ML framework 814 can distribute processes for application or training of the AI model 830 across multiple resources in the hardware platform 810. The ML framework 814 can also include a set of pre-built components that have the functionality to implement and train the AI model 830 and allow users to use pre-built functions and classes to construct and train the AI model 830. Thus, the ML framework 814 can be used to facilitate data engineering, development, hyperparameter tuning, testing, and training for the AI model 830. Examples of ML frameworks 814 that can be used in the AI system 800 include TENSORFLOW, PYTORCH, SCIKIT-LEARN, KERAS, LightGBM, RANDOM FOREST, and AMAZON WEB SERVICES.

The algorithm 816 can be an organized set of computer-executable operations used to generate output data from a set of input data and can be described using pseudocode. The algorithm 816 can include complex code that allows the computing resources to learn from new input data (e.g., the KPIs, counters, and parameters described in more detail with reference to FIGS. 3-6) and create new/modified outputs based on what was learned. In some implementations, the algorithm 816 can build the AI model 830 through being trained while running computing resources of the hardware platform 810. This training allows the algorithm 816 to make predictions or decisions without being explicitly programmed to do so. Once trained, the algorithm 816 can run at the computing resources as part of the AI model 830 to make predictions or decisions, improve computing resource performance, or perform tasks. The algorithm 816 can be trained using supervised learning, unsupervised learning, semi-supervised learning, and/or reinforcement learning.

Using supervised learning, the algorithm 816 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include native-format data collected (e.g., in the form of the KPIs, counters, and parameters described in more detail with reference to FIGS. 3-6) from various source computing systems described in relation to FIG. 1. For example, instead of using conventional digital images, the data can include raw analog signal values of captured images and their parameters. Furthermore, training data can include pre-processed data generated by various engines of the various systems described in relation to FIGS. 3-6. The user may label the training data based on one or more classes and trains the AI model 830 by inputting the training data to the algorithm 816. The algorithm determines how to label the new data based on the labeled training data. The user can facilitate collection, labeling, and/or input via the ML framework 814. In some instances, the user may convert the training data to a set of feature vectors for input to the algorithm 816. Once trained, the user can test the algorithm 816 on new data to determine if the algorithm 816 is predicting accurate labels for the new data. For example, the user can use cross-validation methods to test the accuracy of the algorithm 816 and retrain the algorithm 816 on new training data if the results of the cross-validation are below an accuracy threshold.

Supervised learning can involve classification and/or regression. Classification techniques involve teaching the algorithm 816 to identify a category of new observations based on training data and are used when input data for the algorithm 816 is discrete. Said differently, when learning through classification techniques, the algorithm 816 receives training data labeled with categories (e.g., classes) and determines how features observed in the training data (e.g., images, text, video clips, audio clips, or social media posts) relate to the categories (e.g., a professional context, a romantic conversation, or an educational context). Once trained, the algorithm 816 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 816 is continuous. Regression techniques can be used to train the algorithm 816 to predict or forecast relationships between variables. To train the algorithm 816 using regression techniques, a user can select a regression method for estimating the parameters of the model. The user collects and labels training data that is input to the algorithm 816 such that the algorithm 816 is trained to understand the relationship between data features and the dependent variable(s). Once trained, the algorithm 816 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill in missing data for machine learning based pre-processing operations.

Under unsupervised learning, the algorithm 816 learns patterns from unlabeled training data. In particular, the algorithm 816 is trained to learn hidden patterns and insights of input data, which can be used for data exploration or for generating new data. Here, the algorithm 816 does not have a predefined output, unlike the labels output when the algorithm 816 is trained using supervised learning. Said another way, unsupervised learning is used to train the algorithm 816 to find an underlying structure of a set of data, group the data according to similarities, and represent that set of data in a compressed format.

A few techniques can be used in unsupervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques are density-based methods, hierarchical based methods, partitioning methods, and grid-based methods. In one example, the algorithm 816 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 816 may be trained to be an isolation forest, local outlier factor (LOF) algorithm, or K-nearest neighbor (k-NN) algorithm. Latent variable techniques involve relating observable variables to a set of latent variables. These techniques assume that the observable variables are the result of training on the latent variables and that the observable variables have nothing in common after controlling for the latent variables. Examples of latent variable techniques that may be used by the algorithm 816 include factor analysis, item response theory, latent profile analysis, and latent class analysis.

The model layer 806 implements the AI model 830 using data from the data layer and the algorithm 816 and ML framework 814 from the structure layer 804, thus enabling decision-making capabilities of the AI system 800. The model layer 806 includes a model structure 820, model parameters 822, a loss function engine 824, an optimizer 826, and a regularization engine 828.

The model structure 820 describes the architecture of the AI model 830 of the AI system 800. The model structure 820 defines the complexity of the pattern/relationship that the AI model 830 expresses. Examples of structures that can be used as the model structure 820 include decision trees, support vector machines, regression analyses, Bayesian networks, Gaussian processes, genetic algorithms, and artificial neural networks (or, simply, neural networks). The model structure 820 can include a number of structure layers, a number of nodes (or neurons) at each structure layer, and activation functions of each node. Each node's activation function defines how a node converts data received to data output. The structure layers may include an input layer of nodes that receive input data or an output layer of nodes that produce output data. The model structure 820 may include one or more hidden layers of nodes between the input and output layers. The model structure 820 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 822 represent the relationships learned during training and can be used to make predictions and decisions based on input data. The model parameters 822 can weight and bias the nodes and connections of the model structure 820. For instance, when the model structure 820 is a neural network, the model parameters 822 can weight and bias the nodes in each layer of the neural networks, such that the weights determine the strength of the nodes and the biases determine the thresholds for the activation functions of each node. The model parameters 822, in conjunction with the activation functions of the nodes, determine how input data is transformed into desired outputs. The model parameters 822 can be determined and/or altered during training of the algorithm 816.

The loss function engine 824 can determine a loss function, which is a metric used to evaluate the AI model's performance during training. For instance, the loss function engine 824 can measure the difference between a predicted output of the AI model 830 and the actual output of the AI model 830 and is used to guide optimization of the AI model 830 during training to minimize the loss function. The loss function may be presented via the ML framework 814, such that a user can determine whether to retrain or otherwise alter the algorithm 816 if the loss function is over a threshold. In some instances, the algorithm 816 can be retrained automatically if the loss function is greater than the threshold. Examples of loss functions include a binary-cross entropy function, hinge loss function, regression loss function (e.g., mean square error, or quadratic loss), mean absolute error function, smooth mean absolute error function, log-cosh loss function, and quantile loss function.

The optimizer 826 adjusts the model parameters 822 to minimize the loss function during training of the algorithm 816. In other words, the optimizer 826 uses the loss function generated by the loss function engine 824 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory Broyden-Fletcher-Goldfarb-Shanno (L-BFGS) algorithm. The type of optimizer 826 used may be determined based on the type of model structure 820 and the size of data and the computing resources available in the data layer 802.

The regularization engine 828 executes regularization operations. Regularization is a technique that prevents over-and under-fitting of the AI model 830. Overfitting occurs when the algorithm 816 is overly complex and too adapted to the training data, which can result in poor performance of the AI model 830. Underfitting occurs when the algorithm 816 is unable to recognize even basic patterns from the training data such that it cannot perform well on training data or on validation data. The optimizer 826 can apply one or more regularization techniques to fit the algorithm 816 to the training data properly, which helps constraint the resulting AI model 830 and improves its ability for generalized application. Examples of regularization techniques include lasso (L1) regularization, ridge (L2) regularization, and elastic (L1 and L2 regularization).

The application layer 808 describes how the AI system 800 is used to solve problems or perform tasks. In an example implementation, the application layer 808 can include the NLP model of 310 or the LLMs of 414 or 608.

### Computer System

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A method comprising:
Extracting, from a software release package document, using a natural language processing model, a list of network features, a list of network configuration parameters associated with each network feature, a list of counters associated with each network feature, and a list of key performance indicators (KPIs) associated with each network feature;
mapping each of the extracted network features to at least one extracted network configuration parameter, at least one extracted network performance counter, and at least one extracted KPI;
extracting, from a deployment schedule, a deployment date of a first network feature from the extracted list of network features;
determining a pre statistical trend of a first KPI associated with the first network feature before the deployment date;
determining a post statistical trend of the first KPI associated with the first network feature after the deployment date;
performing a pre-post analysis of a deployment of the first network feature by comparing the pre and the post statistical trends; and
classifying the first KPI as improved, degraded, or stable based on the pre-post analysis,
wherein the first KPI is classified as improved if a difference between the post and the pre statistical trends indicates an improvement in network performance,
wherein the first KPI is classified as degraded if the difference between the post and the pre statistical trends indicates a degradation in network performance, and
wherein the first KPI is classified as stable if the difference between the post and the pre statistical trends indicates no change in network performance.

2. The method of claim 1, wherein performing the pre-post analysis further comprises:
removing at least one anomalous data point from the pre or post statistical trend using a seasonal trend decomposition using a locally estimated scatterplot smoothing (LOESS) algorithm, and
further removing at least one anomalous data point from the pre or post statistical trend using an isolation forest algorithm.

3. The method of claim 2 further comprising, when the first KPI is classified as degraded:
generating, using a large language model, at least one textual instruction for changing a classification of the first KPI to stable or improved.

4. The method of claim 2 further comprising, when the first KPI is classified as stable:
generating, using a large language model, at least one textual instruction for changing a classification of the first KPI to improved.

5. The method of claim 1 further comprising:
determining a Pearson correlation coefficient based on a linear correlation analysis of the first network configuration parameter and the first KPI.

6. The method of claim 1 further comprising:
determining a Spearman's rank correlation coefficient based on a rank-based correlation analysis of the first network configuration parameter and the first KPI.

7. The method of claim 1 further comprising, when the first KPI is classified as degraded:
generating, using a large language model, at least one textual instruction to change the first network configuration parameter from a first value to a second value,
wherein when the first network configuration parameter is changed to the second value, a classification of the first KPI is changed to stable or improved.

8. The method of claim 1 further comprising, when the first KPI is classified as stable:
generating, using a large language model, at least one textual instruction to change the first network configuration parameter from a first value to a second value,
wherein when the first network configuration parameter is changed to the second value, a classification of the first KPI is changed to improved.

9. A method comprising:
extracting, from a deployment schedule, a deployment date of a first network feature;
determining a pre statistical trend of a first KPI associated with the first network feature before the deployment date;
determining a post statistical trend of the first KPI associated with the first network feature after the deployment date;
performing a pre-post analysis of a deployment of the first network feature by comparing the pre and the post statistical trends; and
classifying the first KPI as improved, degraded, or stable based on the pre-post analysis,
wherein the first KPI is classified as improved if a difference between the post and the pre statistical trends indicates an improvement in network performance,
wherein the first KPI is classified as degraded if the difference between the post and the pre statistical trends indicates a degradation in network performance, and
wherein the first KPI is classified as stable if the difference between the post and the pre statistical trends indicates no change in network performance.

10. The method of claim 9, wherein performing the pre-post analysis further comprises:
removing at least one anomalous data point from the pre or post statistical trend using a seasonal trend decomposition using a LOESS algorithm, and
further removing at least one anomalous data point from the pre or post statistical trend using an isolation forest algorithm.

11. The method of claim 10 further comprising, when the first KPI is classified as degraded:
generating, using a large language model, at least one textual instruction for changing a classification of the first KPI to stable or improved.

12. The method of claim 10 further comprising, when the first KPI is classified as stable:
generating, using a large language model, at least one textual instruction for changing a classification of the first KPI to improved.

13. The method of claim 9 further comprising:
determining a Pearson correlation coefficient based on a linear correlation analysis of a first network configuration parameter and the first KPI.

14. The method of claim 9 further comprising:
determining a Spearman's rank correlation coefficient based on a rank-based correlation analysis of a first network configuration parameter and the first KPI.

15. The method of claim 9 further comprising, when the first KPI is classified as degraded:
generating, using a large language model, at least one textual instruction to change a first network configuration parameter from a first value to a second value,
wherein when the first network configuration parameter is changed to the second value, a classification of the first KPI is changed to stable or improved.

16. The method of claim 9 further comprising, when the first KPI is classified as stable:
generating, using a large language model, at least one textual instruction to change a first network configuration parameter from a first value to a second value,
wherein when the first network configuration parameter is changed to the second value, a classification of the first KPI is changed to improved.

17. A non-transitory, computer-readable storage medium comprising instructions recorded thereon, wherein the instructions, when executed by at least one data processor of a system, cause the system to:
extract from a software release package document, using a natural language processing model, a list of network features, a list of network configuration parameters associated with each network feature, a list of counters associated with each network feature, and a list of key performance indicators (KPIs) associated with each network feature;
map each of the extracted network features to at least one extracted network configuration parameter, at least one extracted network performance counter, and at least one extracted KPI;
extract, from a deployment schedule, a deployment date of a first network feature from the extracted list of network features;
determine a pre statistical trend of a first KPI associated with the first network feature before the deployment date;
determine a post statistical trend of the first KPI associated with the first network feature after the deployment date;
perform a pre-post analysis of a deployment of the first network feature by comparing the pre and the post statistical trends; and
classify the first KPI as improved, degraded, or stable based on the pre-post analysis,
wherein the first KPI is classified as improved if a difference between the post and the pre statistical trends indicates an improvement in network performance,
wherein the first KPI is classified as degraded if the difference between the post and the pre statistical trends indicates a degradation in network performance, and
wherein the first KPI is classified as stable if the difference between the post and the pre statistical trends indicates no change in network performance.

18. The non-transitory, computer-readable storage medium of claim 17, wherein causing the system to perform the pre-post analysis further comprises causing the system to:
remove at least one anomalous data point from the pre or post statistical trend using a seasonal trend decomposition using a LOESS algorithm, and
further remove at least one anomalous data point from the pre or post statistical trend using an isolation forest algorithm.

19. The non-transitory, computer-readable storage medium of claim 18, wherein the system is caused to:
when the first KPI is classified as degraded, generate, using a large language model, at least one textual instruction for changing a classification of the first KPI to stable or improved, or
when the first KPI is classified as stable, generate, using a large language model, at least one textual instruction for changing a classification of the first KPI to improved.

20. The non-transitory, computer-readable storage medium of claim 18, wherein the system is caused to:
determine a Pearson correlation coefficient based on a linear correlation analysis of the first network configuration parameter and the first KPI, and
further determine a Spearman's rank correlation coefficient based on a rank-based correlation analysis of the first network configuration parameter and the first KPI.
